(19) United States
(12) Patent Application Publication
(10) Pub. No.: US 2014/0245353 A1
(43) Pub. Date: Aug. 28, 2014

(54) METHODS AND SYSTEMS FOR DISPLAYING MEDIA LISTINGS

(71) Applicant: Ali Raza, San Francisco, CA (US)

(72) Inventor: Ali Raza, San Francisco, CA (US)

(73) Assignee: United Video Properties, Inc., Santa Clara, CA (US)

(21) Appl. No.: 13/778,551

(22) Filed: Feb. 27, 2013

(51) Int. Cl. H04N 21/482

(52) U.S. Cl. CPC H04N 21/4821
USPC 725/44

(57) ABSTRACT

Methods and system are described herein for a media guidance application, which allows a user to more quickly and easily navigate available media listings. Specifically, the media guidance application generates a plurality of media cells each corresponding to a particular media listing. In addition, the media guidance application generates a plurality of presentation criterion cells. Upon selection of a particular presentation criterion cell, the media guidance application reveals media cells that are associated with the particular criterion and conceals media listings that are not associated with the particular criterion.

### BACKGROUND

In conventional systems, a user typically has many program choices available at any one time. As a user is unlikely to know the content of each program, program guides have been developed to present the available programs in an ordered manner. Typical program guides present available programs in a list or grid usually by the channel on which the program is being presented. As the number of channels or programs are too numerous to fit on any one screen, program guides typically allow a user to vertically scroll through different screens displaying the available programs or channels.

Vertically scrolling through multitudes of programs and channels is inherently slow. Moreover, as program guides typically sort the available program by numerical channel order, instead of by subject matter, programs of similar content are often placed sporadically throughout the program guide. Finally, users typically enjoy comparing available programs before selecting a program to watch; however, the sporadic placement of programs within the program guide, and the inefficiency of vertical scrolling, often make comparisons difficult.

### SUMMARY

Accordingly, methods and system are described herein for a media guidance application, which allows a user to more quickly and easily navigate available media listings. Specifically, the media guidance application generates a plurality of media cells, each corresponding to a particular media listing. In addition, the media guidance application generates a plurality of presentation criterion cells. Upon selection of a particular presentation criterion cell, the media guidance application reveals media cells that are associated with the particular criterion and conceals media listings that are not associated with the particular criterion.

In some embodiments, in order for a user to more easily compare media listings associated with different selectable presentation criteria, the media guidance application may maintain the position of a media cell relative to other media cells when the media cell is revealed or concealed. Maintaining the position of the media cell when it is revealed or concealed allows a user to more easily mentally note which media listings are associated with which selectable presentation criteria.

In addition, in some embodiments, the media cells are arranged in a horizontal manner, which provides more intuitive scrolling. For example, in some embodiments, different selectable presentation criteria are arranged in a horizontal row across the middle of the display screen with media cells located above and below the row of selectable presentation criteria. Through the use of directional controls on an input device, a user may select different presentation criteria in order to reveal and/or conceal the media listings associates with any particular presentation criterion.

In some embodiments, the presentation criteria may define various categories or attributes associated with the media listings. For example, the presentation criteria may define a price, a presentation time, a content rating, a genre, or a recommendation level associated with the media listings.

In some embodiments, the media cells may appear as rectangular thumbnails that display information (e.g., a title and/or a graphic), which identifies the media listing associated with the cell. Furthermore, upon selection of the media cell, the media guidance application may generate additional information and/or retrieve the content associated with the media listing.

It should be noted, the systems and/or methods described above may be applied to, or used in accordance with, other systems and/or methods as described below.

### BRIEF DESCRIPTION OF DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance application that may be used to display media listings and/or media assets in accordance with some embodiments of the disclosure;

FIG. 2 shows another illustrative example of a media guidance application that may be used to display media listings and/or media assets in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A is an illustrative example of a display of a media guidance application that allows a user to quickly and easily compare available media listings by displaying media cells associated with the media listings in accordance with some embodiments of the disclosure;

FIG. 5B is an illustrative example of a display of a media guidance application in FIG. 5A after the selection of a presentation criterion cell in accordance with some embodiments of the disclosure;

FIG. 6A is another illustrative example of a display of a media guidance application that allows a user to quickly and easily compare available media listings by displaying media cells associated with the media listings in accordance with some embodiments of the disclosure;

FIG. 6B is an illustrative example of a display of a media guidance application in FIG. 6A after the selection of a media listing in accordance with some embodiments of the disclosure;

FIG. 7 is a flowchart of illustrative steps for revealing and concealing media listings based on a user selection of a presentation criterion in accordance with some embodiments of the disclosure; and

FIG. 8 is a flowchart of illustrative steps displaying a media asset associated with a media listing through the use of a media guidance application in accordance with some embodiments of the disclosure.

### DETAILED DESCRIPTION

The amount of content available to users in any given content delivery system can be substantial. Consequently, many users desire a form of media guidance through an interface that allows users to quickly and easily navigate available media listings associated with available media assets by generating media cells and presentation criterion cells, which are associated with available media listings. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application of this disclosure generates a plurality of media cells each associated with a particular media listing, and generates a plurality of presentation criterion cells, which define particular criteria that correspond to the available media listings. Upon selection of a particular presentation criterion cell, the media guidance application reveals media cells that are associated with the particular criterion of the selected presentation criterion cell and conceals media listings that are not associated with the particular criterion of the selected presentation criterion cell.

As used herein, a “media cell” refers to a defined location in which a media listing may appear on a display screen. The media guidance application may generate a plurality of media cells, in which each media cell is associated with a media listing. The media listing associated with each cell may appear within the media cell (e.g., the media listing associated with the media cell is currently revealed), or the media cell may appear empty (e.g., the media listing associated with the media cell is currently concealed). The plurality of media cells may each have the same dimensions (e.g., a height and length, or a height, length, and width in the case of a three dimensional display) and may appear with the same shape (e.g., a square, rectangle, circle, etc.), or may appear with different dimensions and shapes.

In some embodiments the spacing between, or the sizing of, adjacent media cells may be the same for all media cells displayed on a display screen. For example, in some embodiments, a plurality of media cells may appear equal distance from each other on the display screen, or the plurality of media cells may all be the same size. In some embodiments the spacing between, or size of, adjacent media cells may be different between one or more of the media cells displayed on the display screen. For example, in some embodiments, the plurality of media cells may appear different distances from one or more media listings on the display screen in order to indicate different associations between the media listings (e.g., grouping media listings of the same genre), or the media cells may appear different shapes and/or sizes to indicate a characteristic of the media listing associated with a particular media cell (e.g., a preferred genre of the user).

In some embodiments, the location of a media cell relative to a plurality of other media cells does not change in response to receiving the user input selecting the new presentation criterion. For example, in order to better assist a user in making comparisons between various media listings that are associated with different presentation criteria, the media guidance application may maintain the position of a media listing irrespective of what presentation criterion is selected. By maintaining the position of a media cell associated with a particular media listing, the user may more easily remember which media listings are associated with which presentation criteria because the user may not only associate a media listing with a particular presentation criteria, but also associate the position of the media cell on the display screen with the particular presentation criteria.

In some embodiments, the media guidance application may reveal or conceal a media listing in a media cell in response to a user selecting a presentation criterion. As used herein, “revealing” or “concealing” a media listing in a media cell refers to varying the visual characteristics of the media listing in order to indicate to a user that the media listing corresponds, or does not correspond, to a selected presentation criteria. For example, concealing a media listing in a media cell may involve removing an icon, title, or other graphic from the media cell such that the media cell appears empty. Revealing a media listing, for example, in an empty media cell may involve adding an icon, title, or other graphic such that the previously empty media cell now features the icon, title or other graphic associated with the media listing associated with the media cell.

In some embodiments, revealing or concealing a media listing associated with a media cell may include, but is not limited to, highlighting, boxing, bolding, enlarging, changing the color, shading, obscuring from view, overlaying an object on top of, or otherwise graphically altering one media listing (or media cell) relative to another media asset (or media cell). For example, in order to indicate to a user that a media cell is associated with a media listing that corresponds to a selected presentation criterion, the media guidance application may increase the brightness of the media cell, whereas media cells that are not associated with media listings that correspond to the selected presentation criterion are shaded by the media guidance application.

Additionally or alternatively, the media guidance application may change the shape or size of a media cell in response to a user selection. For example, in some embodiments, the media guidance application may increase the size of a media cell that is associated with a media listing that corresponds to a selected presentation criterion, whereas the size of media cells that are not associated with media listings that correspond to the selected presentation criterion may be decreased by the media guidance application.

As used herein, “presentation criterion” refers to any category or attribute used by the media guidance application to conceal or reveal a media listing. In some embodiments, the media guidance application may receive a selection of a presentation criterion via a user input, a default setting, and/or a remote server that defines a particular group of media listings to conceal or reveal. For example, a presentation criterion may include an availability status (e.g., when the media asset associated with a media listing is available or not available, including, but not limited to, when the presentation of the media asset is initiated and/or terminated, such as when the media asset is broadcasted); may include characteristics of the transmission of the media asset (e.g., a type medium such as a DVD, BLU-RAY, On-Demand, etc.); may include a type of media (e.g., movie, game, music, etc.); may refer to descriptions about the content of the media asset (e.g., genre, subject matter, characters, cast and crew, content rating, etc.); may include recommendations about the media assets (e.g., critical reviews, comments, user generated information, etc.); and/or may include descriptions about accessing the media asset (e.g., subscription information, price information, format information, etc.). In some embodiments, a presentation criterion may include a keyword (e.g., a title of a media asset) and/or an alphanumeric character (e.g., a letter in the title of a media asset).

In some embodiments, one or more presentation criteria may be associated with a selectable presentation criterion cell. As used herein, a “presentation criterion cell” refers to a defined location on a display screen, the selection of which causes the media guidance application to conceal or reveal media listings based on a comparison of the presentation criteria associated with the media listing and the presentation criteria associated with the defined location on the display screen. The media guidance application may generate a plurality of presentation criterion cells, in which each presentation criterion cell is associated with one or more different presentation criteria. The plurality of presentation criterion cells may each have the same dimensions (e.g., a height and length, or a height, length, and width in the case of a three dimensional display) and may appear with the same shape (e.g., a square, rectangle, circle, etc.), or may appear with different dimensions and shapes.

In some embodiments the spacing between, or the sizing of, adjacent presentation criterion cells may be the same for all presentation criterion cells displayed on a display screen. For example, in some embodiments, a plurality of presentation criterion cells may appear equal distance from each other on the display screen, or the plurality of presentation criterion cells may all be the same size. In some embodiments the spacing between, or size of, adjacent presentation criterion cells may be different between one or more of the presentation criterion cells displayed on the display screen. For example, in some embodiments, the plurality of presentation criterion cells may appear different distances, or sizes, from other presentation criterion cells on the display screen in order to indicate different associations between the presentation criterion cells (e.g., grouping presentation criterion cells with one or more common presentation criteria), or the presentation criterion cells may appear different sizes to indicate one or more characteristics of the presentation criterion cell. For example, a particular presentation criterion cell may appear larger than other presentation criterion cells, if the presentation criterion associated the particular presentation criterion cell is also associated with more media listings than the other presentation criterion cells.

The media cells and/or presentation criterion cells may be organized and/or arranged in a way to aid a user in making a selection. For example, in some embodiments, the media guidance application may arrange the media cells and/or presentation criterion cells into horizontal rows. For example, horizontal rows may allow for more intuitive searching, reading and/or scanning by a user as users traditionally search, read, and/or scan in a horizontal manner (e.g., left to right). Additionally or alternatively, the media guidance application may provide multiple pages of media cells and/or presentation criterion cells (e.g., when the number of media cells and/or presentation criterion cells are too numerous for the media guidance application to display on a single page). In some embodiments, the media guidance application may arrange the media cells and/or presentation criterion cells in a carousel formation, in which scrolling to the end of the media cells and/or presentation criterion cells returns users (either seamlessly or after notification) to the beginning of the media cells and/or presentation criterion cells.

In some embodiments, a media listing, media cell, and/or presentation criterion cell may be visually distinguished in response to being selected by a user. As used herein, “visually distinguishing” a media listing, media cell, and/or presentation criterion cell may include any indication to a user that alerts the user to the fact that the media listing, media cell, and/or presentation criterion cell has been selected. In some embodiments, visually distinguishing a media listing, media cell, and/or presentation criterion cell may include highlighting, boxing, bolding, enlarging, changing the color, or otherwise graphically altering the media listing, media cell, and/or presentation criterion cell as displayed on the display screen. In addition, multimedia indications may also be used. For example, the media application may use audio tones and/or audio descriptions (e.g., a verbal announcement of the media listings corresponding to the selected presentation criteria) to indicate the media listing has been selected.

In some embodiments, additional information of a media listing may be presented in response to a user selecting a media asset or in response to a user request for additional information. As used herein, “additional information” refers to any information that may be of interest to a user regarding a media listing or a media asset. For example, additional information may include details about the media listing and/or media asset, including, but not limited to, a title, cast and crew information, production information, textual descriptions about the media asset, user generated comments (e.g., microblog posts and/or any other information published via a social media application), critical reviews, recommendations for similar media assets, links to other content, advertisements, ordering information, subscription status, availability information, and/or available formats. For example, when displaying a movie listing, the media application may present additional information about the media asset or a character in the media asset that other users recently posted on a social network about the movie. In some embodiments, additional information may be displayed on the display screen of a user device in an overlay, on-screen banner, a scrolling ticker, and/or a picture-in-a-picture display. Furthermore, in some embodiments, when presenting the additional information, the media guidance application may reposition or alter the size of one or more media cells in order to accommodate the additional information.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

It should be noted that the embodiments of this disclosure are not limited to any particular display device (e.g., a television) or media asset type. In some embodiments, the methods and systems of this disclosure may be adapted for use with various types of display devices and media assets.

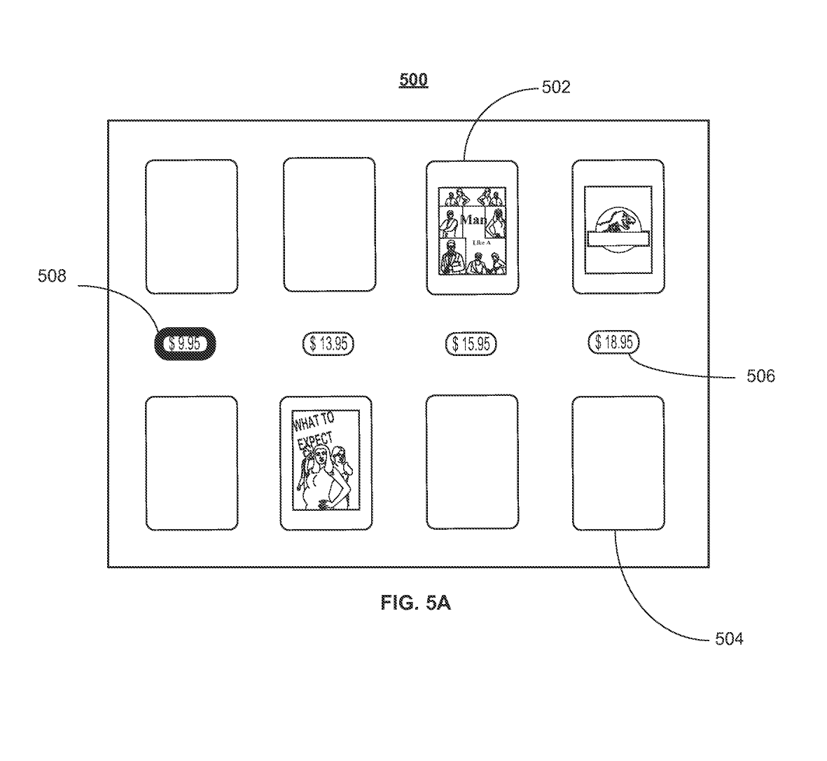

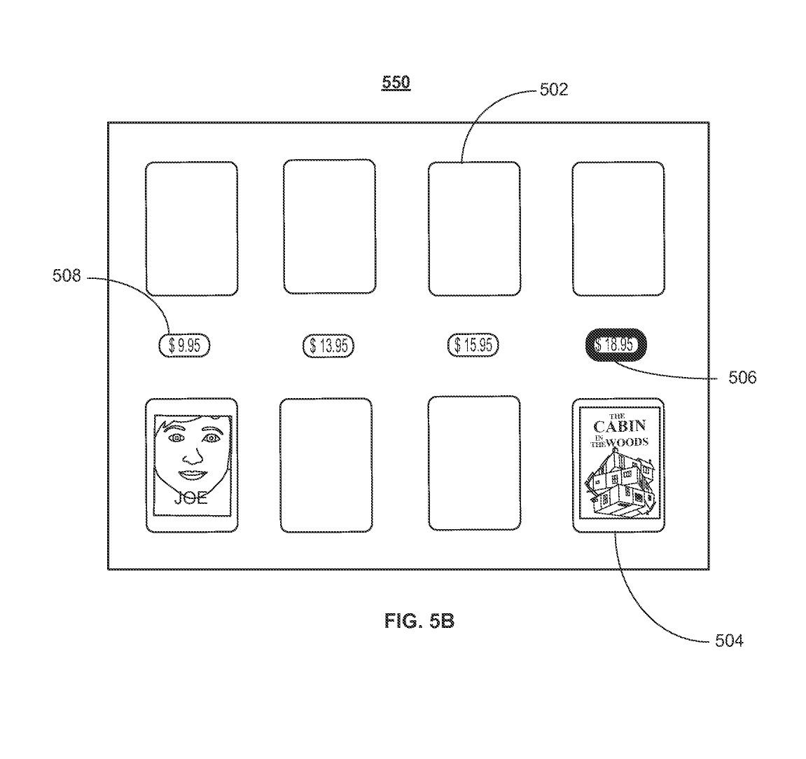

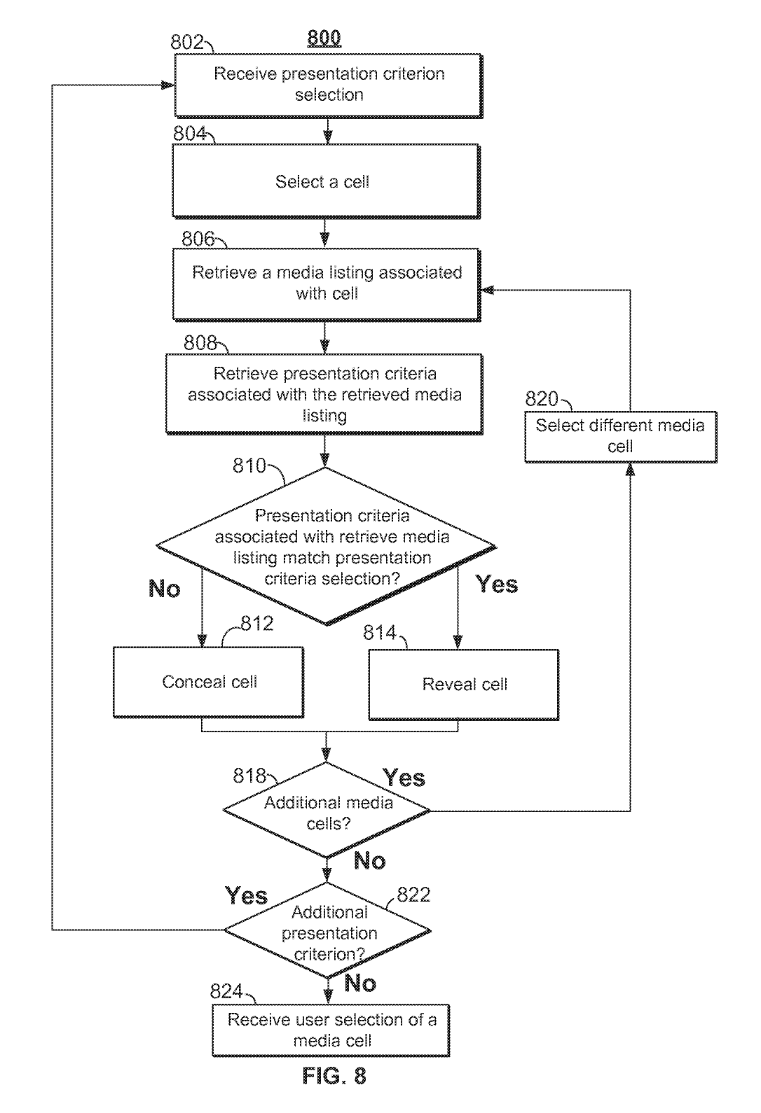

For example, the media application may be adapted to be implemented on a smartphone. The media guidance application may generate for display a plurality of media cells associated with applications available on the smartphone and/or presentation criterion cells associated with characteristics of the application. The presentation criteria associated with applications may be stored on a database (e.g., a local database such as storage 308 (FIG. 3) or a remote database such as media guidance data source 418 (FIG. 4)) and accessed by the media guidance application in order to determine (e.g., via a comparison as discussed below in regards to process 800 (FIG. 8)) what application should be concealed and/or revealed in response to a selection of or more presentation cells.

In another example, the media application may be adapted to be implemented on a menu screen (e.g., in a restaurant, store, and/or internet site) displaying products for sale. The media guidance application may generate for display a plurality of media cells associated with products (e.g., food, services, clothing items, etc.) available on the menu and/or presentation criterion cells associated with characteristics of the products. The presentation criteria associated with products may be stored on a database (e.g., a local database such as storage 308 (FIG. 3) or a remote database such as media guidance data source 418 (FIG. 4)) and accessed by the media guidance application in order to determine (e.g., via a comparison as discussed below in regards to process 800 (FIG. 8)) what products should be concealed and/or revealed in response to a selection of or more presentation cells.

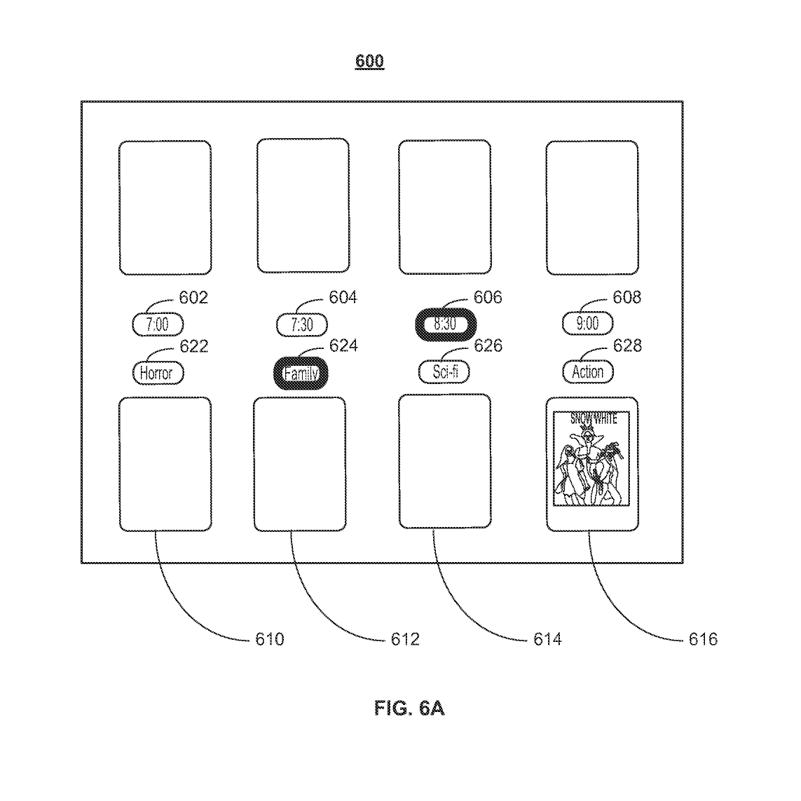

In another example, the media application may be adapted to be implemented on a movie theatre kiosk or movie theatre website to present movies available within a predetermined (or user inputted) start time and/or location. The media guidance application may generate a display that includes a plurality of media cells associated with media listings as well as a plurality of presentation criterion cells. For example, the media guidance application may (e.g., via control circuitry 304 (FIG. 3)) generate media cell 502 (FIG. 5A) of display 500 (FIG. 5A) on a movie theatre kiosk or website (e.g., display 312 (FIG. 3)).

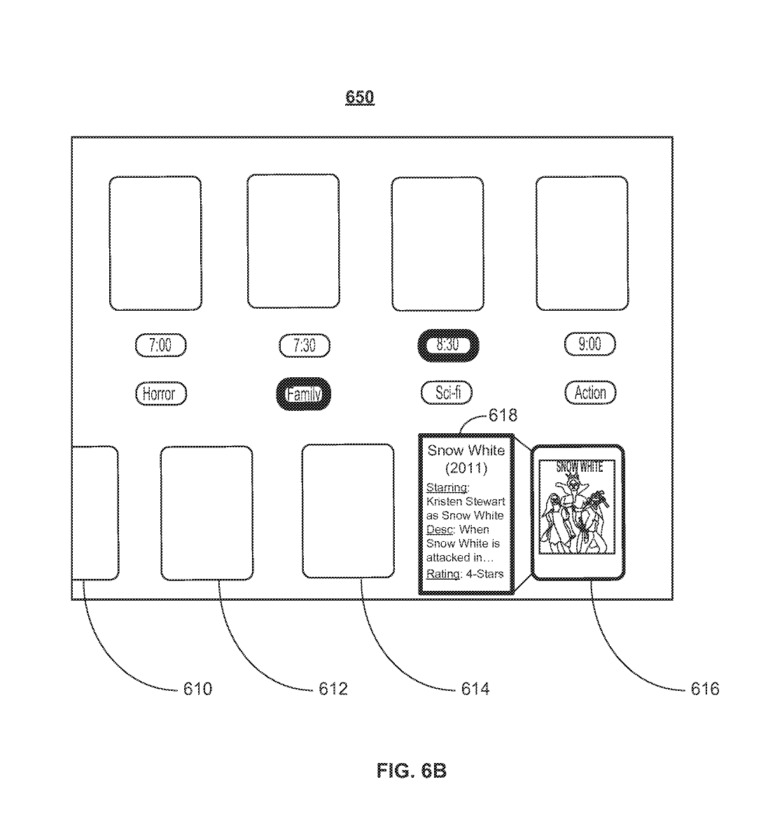

The media guidance application may also generate for display empty media cells associated with media listings corresponding to un-selected presentation criteria. For example, the media guidance application may (e.g., via control circuitry 304 (FIG. 3)) generate media cells 610, 612, and 614 (FIG. 6A) of display 600 (FIG. 6A) on the movie theatre kiosk or website (e.g., display 312 (FIG. 3)).

The media guidance application may receive (e.g., via user input interface 310 (FIG. 3)) a selection of a presentation criterion cell on the movie theatre kiosk (e.g., display 312 (FIG. 3)). In response to the selection, the media guidance application may determine a second media listing that corresponds to the new presentation criterion. For example, the media guidance application may determine whether or not presentation criteria associated with a movie matches the presentation criteria selection (e.g., as discussed below in regards to step 810 (FIG. 8)).

Based on the determination, the media guidance application may also reveal (e.g., via issuing an instruction using control circuitry 304 (FIG. 3) to display 312 (FIG. 3)) the second media listing in one of the empty media cells that is associated with the second media listing on the movie theatre kiosk (e.g., display 312 (FIG. 3)). In some embodiments, the media guidance application, implemented on the movie theatre kiosk or website, may further allow a user to purchase a movie ticket for a particular movie after selecting a media cell associated with the particular movie.

One of the functions of the media guidance application is to provide media guidance data to users. As referred to herein, the phrase, “media guidance data” or “guidance data” should be understood to mean any data related to content, such as media listings, media-related information (e.g., presentation times, presentation channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

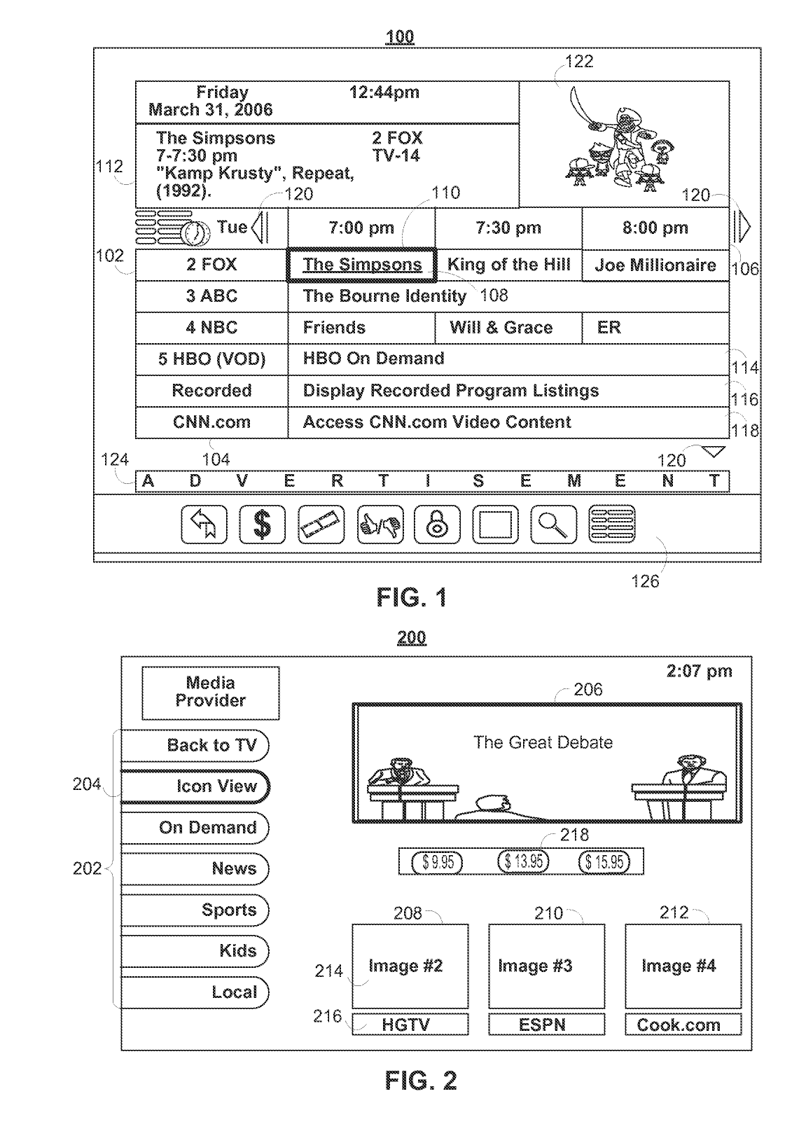

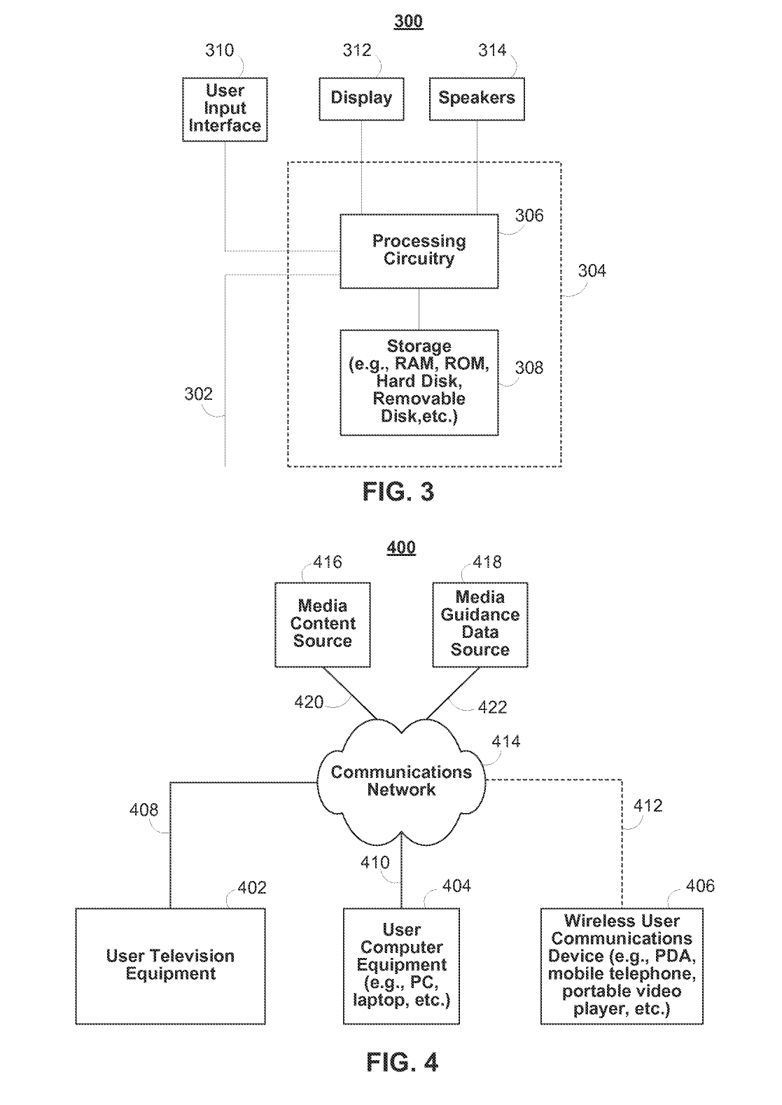

FIGS. 1-2 show illustrative display screens that may be used to provide media guidance data. The display screens shown in FIGS. 1-2, 5A-B, and 6A-B may be implemented on any suitable user equipment device or platform. While the displays of FIGS. 1-2, 5A-B, and 6A-B are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application.

Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, icon view option 204 is selected, thus providing media listings 206, 208, 210, and 212 as media listings corresponding to a group of presentation criteria cells 218. In display 200 the media listings may provide graphical images including cover art, still images from the content, video clip previews, live video from the content, or other types of content that indicate to a user the content being described by the media guidance data in the listing. Each of the graphical media listings may also be accompanied by text to provide further information about the content associated with the listing. For example, media listing 208 may include more than one portion, including media portion 214 and text portion 216. Media portion 214 and/or text portion 216 may be selectable to view content (e.g., additional information) in full-screen or to view information related to the content displayed in media portion 214 (e.g., to view listings for the channel that the video is displayed on).

The media listings in display 200 are of different sizes (i.e., media listing 206 is larger than media listings 208, 210, and 212). In some embodiments, displaying media listing 206 as larger than other media listings may indicate that media guidance application recommends media listing 206 to the user more than the other listings (e.g., based on a comparison with a user profile associated with the user). In some embodiments, if desired, all the media listings may be the same size. Media listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment device 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment device 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment device 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment device 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired).

Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

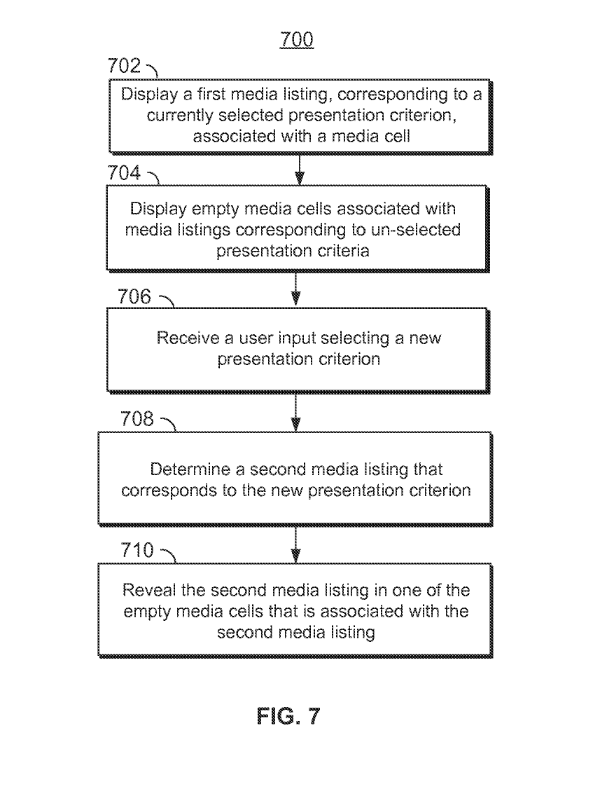

FIG. 5A is an illustrative example of a display of a media guidance application that allows a user to quickly and easily compare available media listings by displaying media cells associated with the media listings in accordance with some embodiments of the disclosure. Display 500 may represent a display (e.g., display 312 (FIG. 3)) on a user device (e.g., user equipment device 402, 404, and/or 406 (FIG. 4)) activated by a user selecting selectable option 204 (FIG. 2)). In some embodiments, display 500 may be generated using one or more steps of process 700 (FIG. 7) or process 800 (FIG. 8) as described below.

Display 500 includes media cell 502 and media cell 504. Media cell 502 currently has a media listing revealed. For example, media cell 502 currently displays a thumbnail image (e.g., including a title and graphic associated with the media content of media listing 502). In contrast, media cell 504 currently has a media listing concealed. For example, media cell 504 currently does not display a thumbnail image.

Although media cell 504 is currently empty the border of media cell 504 is still visible in display 500, indicating that the media listing associated with media cell 504 does not correspond with the currently selected presentation criterion cell. It should be noted that in some embodiments, the border of media cell 504 or any empty media cell may not be visible. For example, in some embodiments, the media guidance application (e.g., via control circuitry 304 (FIG. 3)) may issue an instruction to generate the empty media cell in order to alert the user that the media listing associated with the empty media cell is available for presentation but does not correspond to selected presentation criterion cell.

Display 500 also includes presentation criterion cell 506 and presentation criterion cell 508. Presentation criterion cell 506 and presentation criterion cell 508 correspond to different categories or attributes associated with one or more media listings that are concealed or revealed in display 500. In display 500, presentation criterion cell 508 is currently selected (e.g., via a user input received from user input interface 310 (FIG. 3)) as indicated by the media guidance application visually distinguishing (e.g., generating a dark border around) presentation criterion cell 506. In response to the selection of presentation criterion cell 508, the media guidance application (e.g., via control circuitry 304 (FIG. 3)) reveals the media listings, in the media cells associated with those media listings, that correspond to presentation criterion cell 508.

For example, presentation criterion cell 508 lists a category or attribute (e.g., a purchase price) associated with one or more media listings concealed or revealed in display 500. By revealing a media listing in media cell 502 (e.g., via instructions transmitted to display 312 (FIG. 3) from control circuitry 304 (FIG. 3)), the media guidance application indicates to a user that the media listing associated with media cell 502 fits into or has the category or attribute associated with presentation criterion cell 508. In contrast, by concealing a media listing in media cell 504 (e.g., via instructions transmitted to display 312 (FIG. 3) from control circuitry 304 (FIG. 3)), the media guidance application indicates to a user that the media listing associated with media cell 504 does not fit into or have the category or attribute associated with presentation criterion cell 508.

FIG. 5B is an illustrative example of the display of the media guidance application in FIG. 5A after the selection of presentation criterion cell 506. Display 550 may represent a display (e.g., display 312 (FIG. 3)) on a user device (e.g., user equipment device 402, 404, and/or 406 (FIG. 4)) activated by a user selecting selectable option 204 (FIG. 2)). In some embodiments, display 500 may be generated using one or more steps of process 700 (FIG. 7) or process 800 (FIG. 8) as described below.

In contrast to display 500 (FIG. 5A), in display 550 presentation criterion cell 506 is selected. By revealing a media listing in media cell 504 (e.g., via instructions transmitted to display 312 (FIG. 3) from control circuitry 304 (FIG. 3)), the media guidance application indicates to a user that the media listing associated with media cell 504 fits into or has the category or attribute associated with presentation criterion cell 506. In contrast, by concealing a media listing in media cell 502, the media guidance application indicates to a user that the media listing associated with media cell 502 does not fit into or have the category or attribute associated with presentation criterion cell 506.

For example, in some embodiments, the media guidance application may generate display 500 by determining whether or not the presentation criteria associated with a media listing associated with a media cell matches the presentation criteria selection (e.g., as discussed in relation to step 810 (FIG. 8) below). In some embodiments, the media application may use multiple types of optical character recognition and/or fuzzy logic as discussed below to identify matching criteria.

In some embodiments, the media guidance application may retrieve/receive the presentation criteria associated with a media listing from a local (e.g., storage 308 (FIG. 3)) or remote (e.g., media guidance data source 418 (FIG. 4)) database and compare it (e.g., using control circuitry 304 (FIG. 3)) to the criteria associated with a user selected presentation criterion cell. If the presentation criteria associated with a media listing and the presentation criteria selection match, the media guidance application may issue an instruction (e.g., via control circuitry 304 (FIG. 3)) to the display device (e.g., display 312 (FIG. 3)) to reveal the media cell associated with the media listing. If the presentation criteria associated with a media listing and the presentation criteria selection do not match, the media guidance application may issue an instruction (e.g., via control circuitry 304 (FIG. 3)) to the display device (e.g., display 312 (FIG. 3)) to conceal the media cell associated with the media listing.

FIG. 6A is another illustrative example of a display of a media guidance application that allows a user to quickly and easily compare available media listings by displaying media cells associated with the media listings in accordance with some embodiments of the disclosure. Display 600 may represent a display (e.g., display 312 (FIG. 3)) on a user device (e.g., user equipment device 402, 404, and/or 406 (FIG. 4)) activated by a user selecting selectable option 204 (FIG. 2)). In some embodiments, display 600 may be generated using one or more steps of process 700 (FIG. 7) or process 800 (FIG. 8) as described below.

Display 600 includes a plurality of media cells (e.g., media cell 610, media cell 612, media cell 614, and media cell 616). Media cell 610, media cell 612, and media cell 614 are currently empty. For example, the media listings in media cell 610, media cell 612, and media cell 614 are currently concealed. In contrast, media cell 616 currently has a media listing revealed. For example, media cell 616 currently displays graphical and textual information related to a media listing associated with media cell 616.

Display 600 also includes a first plurality of presentation criterion cells arranged in a horizontal row (e.g., presentation criterion cell 602, presentation criterion cell 604, presentation criterion cell 606, and presentation criterion cell 608) with media cells arranged above and below the horizontal row. Display 600 also includes a second plurality of presentation criterion cells arranged in a horizontal row (e.g., presentation criterion cell 622, presentation criterion cell 624, presentation criterion cell 626, and presentation criterion cell 628). In some embodiments, the second plurality of presentation criterion cells may appear with the first plurality of presentation criterion cells when a user accesses the media guidance application (e.g., via selecting selectable option 204 (FIG. 2)).

In some embodiments, each of the presentation criterion cells in the first and second plurality of presentation criterion cells may correspond to a different presentation criterion in a criteria group. For example, in display 600, each of the presentation criterion cells in the first plurality of presentation criterion cells may correspond to a particular time when different media assets (e.g., movies) are being presented. For example, the first plurality of presentation criterion cells may represent a time period selected (e.g., via user input interface 310 (FIG. 3)) by a user (e.g., movies presented from 7:00 PM to 9:00 PM). The media guidance application may select the criterion to associate with each of the plurality of presentation criterion cells based on criteria associated with available media assets.

For example, in some embodiments, the media guidance application selects the values of each presentation criterion cell based on determining (e.g., via control circuitry 304 (FIG. 3)) that one or more media listings available during the time period have criteria (e.g., a presentation time) matching the values of each presentation criterion cell. For example, in display 600, there is no presentation criterion cell associated with 8:00 PM, indicating that there were not available media listings with presentation criteria (e.g., a presentation time) of 8:00 PM.

In addition, each of the presentation criterion cells in the second plurality of presentation criterion cells may correspond to a particular genre of media asset. For example, the second plurality of presentation criterion cells may represent one or more of the different genres of movies. In some embodiments, the second plurality of presentation criterion cells may be generated only after a user selection (e.g., via user input interface 310 (FIG. 3)) of one of the first plurality of presentation criterion cells (e.g., as discussed below in relation to process 800 (FIG. 8)). For example, the second plurality of presentation criterion cells may represent a sub-category of one of the first plurality of presentation criterion cells that was selected. For example, the second plurality of presentation criterion cells associated with “Horror,” “Family,” “Sci-fi,” and “Action” may represent the different genres of movies that are available at 8:30. Likewise, the selection of one of the second plurality of presentation criterion cells may generate additional pluralities of presentation criterion cells.

In some embodiments, the one or more plurality of criterion cells that are generated in response to a user selection of a presentation criterion cell in the first plurality of presentation criterion cells may be determined by the media guidance application (e.g., via control circuitry 304 (FIG. 3)). In some embodiments, the one or more plurality of criterion cells may be based on information retrieved/received from a local (e.g., storage 308 (FIG. 3)) or remote (e.g., media guidance data source 418 (FIG. 4)) database. Furthermore, in some embodiments, the media listings (and media cells associated with those media listings) that correspond to the criterion in each of the presentation criterion cells may also be based on information retrieved/received from a local (e.g., storage 308 (FIG. 3)) or remote (e.g., media guidance data source 418 (FIG. 4)) database.

For example, the first plurality of presentation criterion cells may correspond to available movie theatres. Selection of a presentation criterion cell associated with a particular movie theatre may cause the media guidance application to generate a second plurality of presentation criterion cells corresponding to movie times at the movie theatre that corresponds to the selected presentation criterion cell of the first plurality of presentation criterion cells.

In display 600, presentation criterion cell 606 and presentation cell 624 are currently selected (e.g., via a user input received from user input interface 310 (FIG. 3)) as indicated by the media guidance application visually distinguishing (e.g., generating a dark border around) presentation criterion cell 606 and presentation cell 624. In response to the selection of presentation criterion cell 606 and presentation cell 624, the media guidance application (e.g., via control circuitry 304 (FIG. 3)) reveals a media listing, in a media cell (e.g., media cell 616) associated with those media listings, that corresponds to presentation criterion cell 606 and presentation cell 624.

For example, presentation criterion cell 606 lists the presentation time associated with the media listing associated with media cell 616, and presentation cell 624 lists the genre associated with the media listing associated with media cell 616. By revealing a media listing in media cell 616 (e.g., via instructions transmitted to display 312 (FIG. 3) from control circuitry 304 (FIG. 3)), the media guidance application indicates to a user that the media listing associated with media cell 616 has a presentation time of 8:30 PM (e.g., the presentation time displayed by presentation criterion cell 606) and a genre of family (e.g., the genre displayed by presentation criterion cell 624). In contrast, by concealing media listings in media cell 610, media cell 612, and media cell 614 (e.g., via instructions transmitted to display 312 (FIG. 3) from control circuitry 304 (FIG. 3)), the media guidance application indicates to a user that the media listings associated with those cells do not have a presentation time of 8:30 PM or a genre of family.

FIG. 6B is an illustrative example of a display of a media guidance application in FIG. 6A after the selection of a media listing in accordance with some embodiments of the disclosure. Display 650 may represent a display (e.g., display 312 (FIG. 3)) on a user device (e.g., user equipment device 402, 404, and/or 406 (FIG. 4)) activated by a user selecting selectable option 204 (FIG. 2)). In some embodiments, display 650 may be generated using one or more steps of process 700 (FIG. 7) or process 800 (FIG. 8) as described below.

In display 650, a user (e.g., via user input interface 310 (FIG. 3)) has selected media cell 616. In response to the selection of media cell 616, the media guidance application (e.g., via control circuitry 304 (FIG. 3)) issues instructions to a display device (e.g., display 312 (FIG. 3)) to visually distinguish media cell 616.

Additionally, in response to a user selection of media cell 616, the media guidance application (e.g., via control circuitry 304 (FIG. 3)) issues instructions to a display device (e.g., display 312 (FIG. 3)) to display additional information 618 about the media listing associated with media cell 616. Additional information 618 appears as a pop-up on display 650. Furthermore, media cell 610, media cell 612, and media cell 614 have been laterally translated in order to provide room on display 650 for additional information 618. Additionally or alternatively, in some embodiments, additional information 618 may appear as an overlay on one or more media cells. Furthermore, in some embodiments, the appearance of additional information 618 on display 650 may not result in the movement of one or more media cells in display 650 with respect to one or more other media cells in display 650.

FIG. 7 is a flowchart of illustrative steps for revealing and concealing media listings based on a user selection of a presentation criterion in accordance with some embodiments of the disclosure. For example, in some embodiments, process 700 may be used to generate the display screens in FIGS. 1, 2, 5A-B, and 6A-B. It should be noted that process 700 or any step thereof could be provided by any of the devices shown in FIGS. 3-4. For example, process 700 may be executed by control circuitry 304 (FIG. 3) as instructed by a media guidance application implemented on user equipment device 402, 404, and/or 406 (FIG. 4) to generate display 500 (FIG. 5A) on a display incorporated into, or accessible by, the media guidance application (e.g., display 312 (FIG. 3)).

At step 702, the media guidance application generates for display a first media listing, corresponding to a currently selected presentation criterion, associated with a media cell. For example, the media guidance application may (e.g., via control circuitry 304 (FIG. 3)) generate media cell 502 (FIG. 5A) of display 500 (FIG. 5A) on a display device (e.g., display 312 (FIG. 3)) of a user device (e.g., user equipment device 402, 404, and/or 406 (FIG. 4)).

At step 704, the media guidance application generates for display empty media cells associated with media listings corresponding to un-selected presentation criteria. For example, the media guidance application may (e.g., via control circuitry 304 (FIG. 3)) generate media cells 610, 612, and 614 (FIG. 6A) of display 600 (FIG. 6A) on a display device (e.g., display 312 (FIG. 3)) of a user device (e.g., user equipment device 402, 404, and/or 406 (FIG. 4)).

At step 706, the media guidance application receives a user input selecting a new presentation criterion. For example, the media guidance application may receive (e.g., via user input interface 310 (FIG. 3)) a selection, for example, as indicated by the highlighting of a presentation criterion (e.g., presentation criterion cell 508 (FIG. 5)) of a presentation criterion cell on a display device (e.g., display 312 (FIG. 3)) of a user device (e.g., user equipment device 402, 404, and/or 406 (FIG. 4)).

At step 708, the media guidance application determines a second media listing that corresponds to the new presentation criterion. For example, the media guidance application may determine whether or not a presentation criteria associated with a retrieve media listing matches the presentation criteria selection as discussed below in regards to step 810 (FIG. 8)). In some embodiments, the media guidance application may compute a determination locally (e.g., using processing circuitry 306 (FIG. 3)) or remotely (e.g., via transmitting a signal indicating the presentation criterion that was selected to a remote server such as media guidance data source 418 (FIG. 4) and receiving a signal from the remote server indicating the media listings with matching presentation criteria).

At step 710, the media guidance application reveals the second media listing in one of the empty media cells that is associated with the second media listing. For example, the media guidance application may reveal (e.g., via issuing an instruction using control circuitry 304 (FIG. 3) to display a title associated with the second media listing) the second media listing (e.g., media cell 504 as shown in FIG. 6B) on a display device (e.g., display 312 (FIG. 3)) of a user device (e.g., user equipment device 402, 404, and/or 406 (FIG. 4)).

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

FIG. 8 is a flowchart of illustrative steps displaying content associated with a media listing through the use of a media guidance application in accordance with some embodiments of the disclosure. For example, in some embodiments, process 800 may be used to generate the display screens in FIGS. 1, 2, 5A-B, and 6A-B. It should be noted that process 800 or any step thereof could be provided by any of the devices shown in FIGS. 3-4. For example, process 800 may be executed by control circuitry 304 (FIG. 3) as instructed by a media guidance application implemented on user equipment device 402, 404, and/or 406 (FIG. 4) to generate display 500 (FIG. 5A) on a display incorporated into, or accessible by, the media guidance application (e.g., display 312 (FIG. 3)).

At step 802, the media guidance application receives a presentation criterion selection. For example, the media guidance application may receive (e.g., via user input interface 310 (FIG. 3)) a selection, for example, as indicated by the highlighting of a presentation criterion (e.g., presentation criterion cell 508 (FIG. 5)) of a presentation criterion cell on a display device (e.g., display 312 (FIG. 3)) of a user device (e.g., user equipment device 402, 404, and/or 406 (FIG. 4)).

At step 804, the media guidance application selects a cell. For example, in some embodiments, the media guidance may perform multiple iterations of process 800 for each media cell (e.g., media cell 502 (FIG. 5)) of a plurality of media cells in a display (e.g., display 500 (FIG. 5)) on a display device (e.g., display 312 (FIG. 3)) incorporated into, or accessible by, a user device (e.g., user equipment device 402, 404, and/or 406 (FIG. 4)). The media cells in a display (e.g., display 500 (FIG. 5A)) and the media listings associated with those media cells may, in some embodiments, represent all available media listings that correspond to a displayed group of presentation criterion cells (e.g., presentation criterion cells 602, 604, 606, and 608 (FIG. 6A)).

At step 806, the media guidance application retrieves a media listing associated with a cell. For example, each media cell may be associated with a media listing. The media listing may be stored on a local database (e.g., storage 308 (FIG. 3)) or on a remote database (e.g., content source 416 (FIG. 4), media guidance data source 418 (FIG. 4), and/or any other device/location accessible via communications network 414 (FIG. 4)). For example, in some embodiments, in order for a user to more easily compare the various media listings (e.g., media listing 610, 612, 614, and 616 (FIG. 6A)) associated with different selectable presentation criteria, the media guidance application may maintain the position of a media cell relative to other media cells when the media cell is revealed or concealed. In some embodiments, the position of the cell as determined by the media guidance application may indicate degrees of interest to the user or to emphasize certain content, as desired by the content provider or based on user preferences.

At step 808, the media guidance application retrieves presentation criteria associated with the retrieved media listing. For example, a media listing may have various presentation criteria that correspond to categories or attributes of the media listings (e.g., a presentation time, a recommendation level, etc.) In some embodiments, the various presentation criteria corresponding to the media listing may be transmitted with a media listing or the content associated with the media listing (e.g., in metadata), or the various presentation criteria corresponding to the media listing may be stored on a local database (e.g., storage 308 (FIG. 3)) or on a remote database (e.g., content source 416 (FIG. 4), media guidance data source 418 (FIG. 4), and/or any other device/location accessible via communications network 414 (FIG. 4)).

At step 810, the media guidance application determines whether or not the presentation criteria associated with retrieve media listing matches the selected presentation criteria selection. In some embodiments, the media application may use multiple types of optical character recognition and/or fuzzy logic; for example, when processing presentation criteria, keywords related to presentation criteria, and/or any other information that indicates presentation criteria associated with the retrieved media listing from data with a media listing. For example, if the particular data received is textual data, using fuzzy logic, the media application may determine two fields and/or values to be identical even though the substance of the data or value (e.g., two different spellings) is not identical.

If the media guidance application determines that the presentation criteria associated with a retrieved media listing does not match the presentation criteria selection, the media guidance application conceals the media cell at step 812. For example, the media guidance application may remove, shade, or otherwise obscure the title of the media listing from the media cell associated with the media listing. If the media guidance application determines that the presentation criteria associated with retrieved media listing matches the presentation criteria selection, the media guidance application reveals the media cell at step 814. For example, the media guidance application may display the title of the media listing from the media cell associated with the media listing.

At step 818, the media guidance application determines whether or not there are additional media cells in the display. If there are additional media cells, the media guidance application proceeds to step 820, selects a different media cell, and returns to step 806. If there are not additional media cells, the media guidance application proceeds to step 822.

At step 822, the media guidance application determines whether or not there are additional presentation criteria. For example, in some embodiments, the media guidance application may present several tiers of presentation criterion cells (e.g., as discussed in relation to FIGS. 6A-B above). If the media guidance application determines that there are additional presentation criteria to display (e.g., on display 312 (FIG. 3)) to a user, the media guidance application generates presentation criterion cells for the new presentation criteria (e.g., presentation criterion cells 622, 624, 626, and 628 (FIG. 6A)) on the display screen (e.g., display 600 (FIG. 6A)).

The media guidance application then returns to step 802 to receive a new presentation criterion selection for the new presentation criteria. In the second iteration of process 800 (e.g., for the new presentation criterion selection), the media guidance application may, at step 812, conceal media cells that were previously revealed during previous iterations.

In some embodiments, the new presentation criteria may represent a category or sub-category associated with the previously presentation criterion selection (e.g., the presentation criterion selected during a previous iteration of process 800). For example, if a previous presentation criterion selection determined a particular presentation time of a media asset, the new presentation criteria may allow the user to select a particular price of media assets having the particular presentation time.

If the media guidance application determines that there are no additional presentation criteria to display (e.g., on display 312 (FIG. 3)) to a user, the media guidance application proceeds to step 824. For example, the media guidance application may present the media assets (e.g., on display 312 (FIG. 3)) that are revealed as a result of the one or more iterations of process 800.

At step 824, the media guidance application receives a user selection of a revealed media cell (e.g., as discussed in relation to FIG. 6B). In some embodiments, in response to a user selection of the revealed media cell, the media guidance application may generate additional information (e.g., as discussed in relation to FIG. 6B) about the media listing associated with the media cell. Additionally or alternatively, in some embodiments, in response to a user selection of the revealed media cell, the media guidance application may retrieve a media asset associated with the selected media cell (e.g., from content source 416 (FIG. 4)) for presentation to the user (e.g., on display 312 (FIG. 3) of user equipment device 402, 404, and/or 406 (FIG. 4)).

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for displaying media listings, the method comprising:
generating, using control circuitry, a display of a first media listing associated with a media cell on a display screen, wherein the first media listing corresponds to a currently selected presentation criterion;
generating, using the control circuitry, a display of a plurality of empty media cells, wherein the plurality of empty media cells are associated with media listings corresponding to un-selected presentation criteria, and wherein representations of the plurality of empty media cells are visible to a user;
in response to receiving a user input selecting a new presentation criterion, determining a second media listing that corresponds to the new presentation criterion; and
revealing, using the control circuitry, the second media listing in one of the empty media cells that is associated with the second media listing.

2. The method of claim 1, further comprising:
determining whether the first media listing corresponds to the new presentation criterion; and
in response to determining the first media listing does not correspond to the new presentation criterion, concealing the first media listing.

3. The method of claim 1, wherein a size the media cell relative to the plurality of empty media cells does not change in response to receiving the user input selecting the new presentation criterion.

4. The method of claim 1, wherein a location of the media cell relative to the plurality of empty media cells does not change in response to receiving the user input selecting the new presentation criterion.

5. The method of claim 1, wherein the currently selected presentation criterion defines a price, a presentation time, a content rating, a genre, or a recommendation level associated with the first media listing.

6. The method of claim 1, further comprising transmitting an instruction to visually distinguish the second media listing in response to a user selection of the second media listing.

7. The method of claim 1, further comprising transmitting an instruction to display additional information associated with the second media listing in response to a user selection of the second media listing.

8. The method of claim 1, further comprising transmitting an instruction to display the first media listing as an icon comprising a title associated with the first media listing and a graphic associated with the first media listing.

9. The method of claim 1, further comprising generating a plurality of selectable presentation criterion cells, wherein each of the selectable presentation criterion cells corresponds to a different presentation criterion in a criteria group.

10. The method of claim 9, further comprising:
transmitting an instruction to display the plurality of presentation selectable criterion cells in a horizontal row;
transmitting an instruction to display the media cell above the plurality of presentation selectable criterion cells in the horizontal row; and
transmitting an instruction to display at least one of the empty media cells below the plurality of presentation selectable criterion cells in the horizontal row.

11. A system for displaying media listings, the system comprising control circuitry configured to:
generate, on a display device, a display of a first media listing associated with a media cell, wherein the first media listing corresponds to a currently selected presentation criterion;
generate, on the display device, a display of a plurality of empty media cells, wherein the plurality of empty media cells are associated with media listings corresponding to un-selected presentation criteria, and wherein representations of the plurality of empty media cells are visible to a user;
in response to receiving a user input selecting a new presentation criterion, determine a second media listing that corresponds to the new presentation criterion; and
reveal the second media listing in one of the empty media cells that is associated with the second media listing on a display device.

12. The system of claim 11, wherein the control circuitry is further configured to:
determine whether the first media listing corresponds to the new presentation criterion; and
in response to determining that the first media listing does not correspond to the new presentation criterion, conceal the first media listing.

13. The system of claim 11, wherein a size the media cell relative to the plurality of empty media cells does not change in response to receiving the user input selecting the new presentation criterion.

14. The system of claim 11, wherein a location of the media cell relative to the plurality of empty media cells does not change in response to receiving the user input selecting the new presentation criterion.

15. The system of claim 11, wherein the currently selected presentation criterion defines a price, a presentation time, a content rating, a genre, or a recommendation level associated with the first media listing.

16. The system of claim 11, wherein the control circuitry is further configured to transmit an instruction to visually distinguish the second media listing on the display device in response to a user selection of the second media listing.

17. The system of claim 11, wherein the control circuitry is further configured to transmit an instruction to display additional information associated with the second media listing on the display device in response to a user selection of the second media listing.

18. The system of claim 11, wherein the control circuitry is further configured to transmit an instruction to display the first media listing as an icon comprising a title associated with the first media listing and a graphic associated with the first media listing on the display device.

19. The system of claim 11, wherein the control circuitry is further configured to generate a plurality of selectable presentation criterion cells, wherein each of the selectable presentation criterion cells corresponds to a different presentation criterion in a criteria group, on the display device.

20. The system of claim 19, wherein the control circuitry is further configured to:
transmit an instruction to display, on the display device, the plurality of selectable presentation criterion cells in a horizontal row;
transmit an instruction to display, on the display device, the media cell above the plurality of selectable presentation criterion cells in the horizontal row; and
transmit an instruction to display, on the display device, at least one of the empty media cells below the plurality of selectable presentation criterion cells in the horizontal row.

21-30. (canceled)

31. The method of claim 1, wherein the representations of the plurality of empty media cells include a visible boundary for each of the plurality of empty media cells.

32. The system of claim 11, wherein the representations of the plurality of empty media cells include a visible boundary for each of the plurality of empty media cells.
